(19) United States
(12) Patent Application Publication
(10) Pub. No.: US 2016/0111776 A1
(43) Pub. Date: Apr. 21, 2016

(54) RADIO WAVE TRANSMISSIVE COVER

(71) Applicant: TOYODA GOSEI CO., LTD., Kiyosu-shi (JP)

(72) Inventors: Koji OKUMURA, Kiyosu-shi (JP); Hideto MAEDA, Kiyosu-shi (JP); Kazuki TAKAO, Kiyosu-shi (JP); Kenji SUZUKI, Kiyosu-shi (JP); Kinji FURUKAWA, Kiyosu-shi (JP); Daiichiro KAWASHIMA, Kiyosu-shi (JP)

(21) Appl. No.: 14/844,104

(22) Filed: Sep. 3, 2015

(30) Foreign Application Priority Data
Oct. 15, 2014 (JP) 2014-210951

(51) Int. Cl. H01Q 1/42

(52) U.S. Cl. CPC H01Q 1/422

(57) ABSTRACT

A radio wave transmissive cover is arranged in a path of a radio wave of a millimeter wave radar device. The cover includes a transparent member, which serves as the surface of the cover, and an ornamental layer, which is formed on the rear surface of the transparent member. The transparent member is formed from polyester copolymerized polycarbonate.

### TECHNICAL FIELD

The present invention relates to a radio wave transmissive cover arranged in a radio wave path of a radio wave radar device.

### BACKGROUND ART

Millimeter wave radar devices are nowadays installed in vehicles such as automobiles to measure the distance between the corresponding vehicle and a nearby vehicle or an obstacle. When the millimeter wave radar device is exposed to the outside of the vehicle, the millimeter wave radar device may adversely affect the aesthetic appeal of the vehicle. Thus, the millimeter wave radar device is arranged at, for example, the rear side of an emblem or a radiator grille located at the front side of the vehicle, and the emblem is used as a radio wave transmissive cover (hereinafter referred to as the cover). Refer to, for example, Japanese Laid-Open Patent Publication No. 2002-131413.

Water drops, such as rain water, that collect on the surface of the cover may greatly attenuate the millimeter waves transmitted through the cover when the millimeter waves pass through the water drops on the cover surface.

In the above publication, polycarbonate is used in the surface of the cover. Further, the cover surface undergoes a water repellent treatment. Thus, the cover has high water repellency, and water drops easily fall off the cover.

Further, in a conventional radio wave transmissive cover, a hard coating is generally applied to the surface of a polycarbonate transparent member to increase the impact resistance. Such a hard coating also has high water repellency.

Even though the surfaces of such covers have high water repellency, when water drops are collected on the cover surface and the millimeter waves are transmitted through the water drops, the water drops still greatly attenuate the millimeter waves.

### SUMMARY OF THE INVENTION

It is an object of the present invention to provide a radio wave transmissive cover that is capable of limiting attenuation when radio waves are transmitted even if water drops are collected on the surface of the cover.

A radio wave transmissive cover is arranged in a path of a radio wave of a radio wave radar device. The radio wave transmissive cover includes a transparent member that serves as a surface of the cover. The transparent member is formed from a resin material adapted so that when a water drop falls onto the surface, a contact angle of the surface and the water drop is 80° or greater and 90° or less.

### BRIEF DESCRIPTION OF THE DRAWINGS

FIG. 1 is a front view showing one embodiment of a radio wave transmissive cover.

FIG. 2 is a cross-sectional view taken along line 2-2 in FIG. 1.

FIG. 3 is an enlarged cross-sectional view showing the main section of the radio wave transmissive cover of FIG. 2.

FIGS. 4A to 4C are schematic diagrams each showing the form of a water drop on the surface of the cover, in which FIG. 4A is a diagram showing the water drop when a contact angle θc is larger than 90°, FIG. 4B is a diagram showing the water drop when the contact angle θc is 90°, and FIG. 4C is a diagram showing the water drop when the contact angle θc is smaller than 90°.

FIG. 5 is a graph showing the relationship of the contact angle and the attenuation amount of millimeter waves.

### EMBODIMENTS OF THE INVENTION

A radio wave transmissive cover according to one embodiment of the present invention will now be described with reference to FIGS. 1 to 5. In the drawings, each member is illustrated to be discernible and thus not in scale.

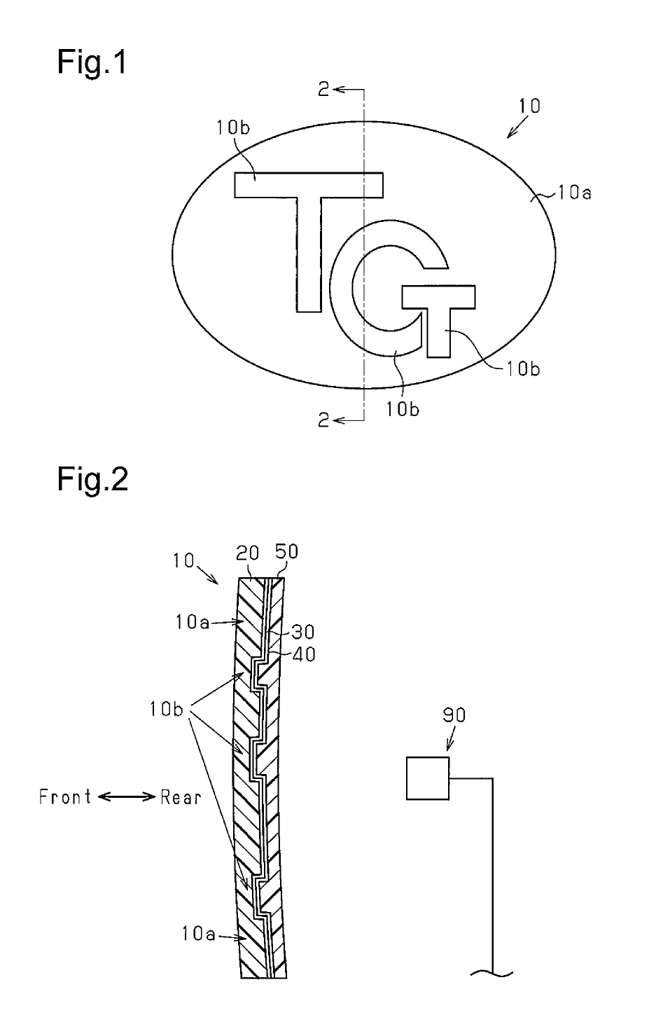

As shown in FIGS. 1 and 2, a radio wave transmissive cover (hereinafter referred to as the cover 10) is an emblem attached to an opening of a radiator grille, which is arranged at the front side of a vehicle. The cover 10 is located in front of a millimeter wave radar device 90, which is arranged in the radiator grille of the vehicle. The cover 10 is arranged in a path of radio waves (millimeter waves) of the millimeter wave radar device 90.

As shown in FIG. 2, the cover 10 includes a transparent member 20, which serves as the surface of the cover 10. In the present embodiment, the transparent member 20 is formed from polyester copolymerized polycarbonate, which has superior impact resistance, weather resistance, and water absorption resistance.

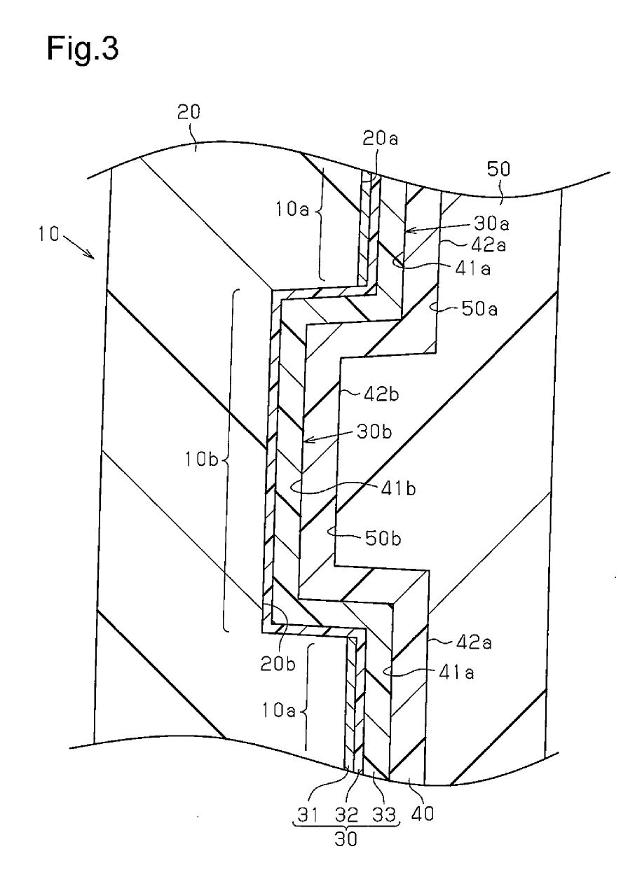

As shown in FIG. 3, the rear surface of the transparent member 20 includes a flat portion 20a and a recess 20b, which is located toward the front of the flat portion 20a. The depth of the recess 20b is approximately 3.0 mm. The flat portion 20a corresponds to a background region 10a of the cover 10, which is shown in FIGS. 1 to 3. The recess 20b corresponds to a character region 10b of the cover 10, which is shown in FIGS. 1 to 3.

As shown in FIGS. 2 and 3, an ornamental layer 30 is formed on the rear surface of the transparent member 20. As shown in FIG. 3, the ornamental layer 30 includes a colored layer 31, a metal layer 32, and an anti-corrosion layer 33. The colored layer 31 is printed, for example, in black on the flat portion 20a in the rear surface of the transparent member 20. The metal layer 32 is formed by vapor-depositing a metal material on the rear surface of the transparent member 20 in the recess 20b and on the entire rear surface of the colored layer 31. The anti-corrosion layer 33 is painted on the entire rear surface of the metal layer 32. The metal layer 32 is formed from, for example, indium and has a thickness of approximately 20 nm. The anti-corrosion layer 33 hinders corrosion of the metal layer 32. The anti-corrosion layer 33 is formed from an acrylic or urethane resin material and has a thickness of several tens of micrometers. Accordingly, the rear surface of the anti-corrosion layer 33, that is, the rear surface of the ornamental layer 30, includes a flat portion 30a and a recess 30b. The flat portion 30a and the recess 30b correspond to the flat portion 20a and the recess 20b of the transparent member 20, respectively. The heat withstanding temperature of the anti-corrosion layer 33 is approximately 200° C.

A buffer 40 is arranged on the rear surface of the anti-corrosion layer 33 to cover the entire rear surface of the anti-corrosion layer 33. The buffer 40 is shaped in conformance with the rear surface of the ornamental layer 30. The front surface of the buffer 40 includes a flat portion 41a, which is adhered to the rear surface of the ornamental layer 30, and a projection 41b, which is adhered to the recess 30b in the rear surface of the ornamental layer 30. The buffer 40, which is molded in advance, is formed from a resin material such as polyamide resin. It is preferred that the thickness of the buffer 40 be in a range from 0.1 mm to 1.0 mm. In the present embodiment, the thickness of the buffer 40 is approximately 0.6 mm, and the heat withstanding temperature of the buffer member 40 is approximately 140° C. The buffer 40 is arranged to reduce the movement of heat to the transparent member 20 when insert-molding of a base 50 is performed. When molding the base 50, the buffer 40 may be omitted when heat damage is tolerable in at least one of the transparent member 20 and the ornamental layer 30. More specifically, the buffer 40 may be omitted when the heat deflection temperature of the transparent member 20 is 115° C. or greater, and the buffer 40 is used when the temperature is less than 115° C. The heat deflection temperature is a value based on a testing method in compliance with ISO 75.

The base 50 is formed on the rear surface of the buffer 40. The base 50 is formed from acrylonitrile-ethylene-propylene-diene styrene resin (AES resin). The front surface of the base 50 is shaped in conformance with the rear surface of the buffer 40. The front surface of the base 50 includes a flat portion 50a, which is adhered to the rear surface of the buffer 40 on the flat portion 42a, and a projection 50b, which is adhered to the recess 42b in the rear surface of the buffer 40.

The operation of the present embodiment will now be described.

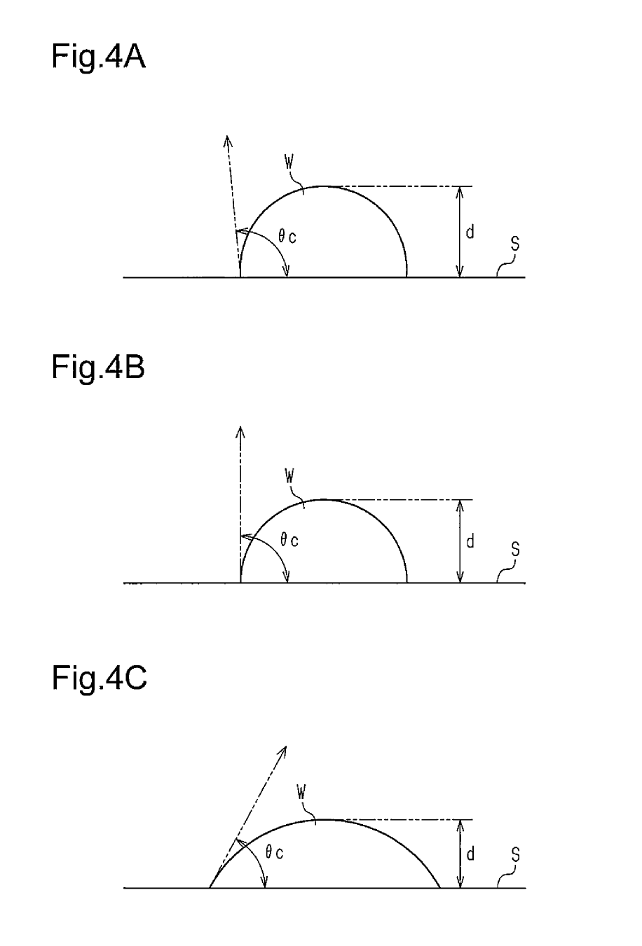

FIGS. 4A to 4C each show the form of a water drop on the cover surface in relation with the contact angle θc.

As shown in FIG. 4A, when the contact angle θc of the cover surface S and a water drop W is larger than 90°, a water drop W has a generally semi-spherical shape that is close to a spherical shape. As shown in FIG. 4B, when the contact angle θc of the cover surface S and the water drop W is 90°, the water drop W has a spherical shape. As shown in FIG. 4C, when the contact angle θc of the cover surface S and the water drop W is smaller than 90°, the water drop wets and spreads on the cover surface S. Water is apt to wet and spread on the surface of the cover as the contact angle θc decreases.

A cover of a first comparison example includes a transparent member, which is formed from polycarbonate, and a hard coating, which is formed from acrylic resin and applied to the surface of the transparent member.

In the cover of the first comparison example, the hard coating has high water repellency. Thus, when a water drop W such as rain water falls onto the surface of the cover, the water drop W has a semi-spherical shape that is close to a spherical shape, and the contact angle θc of the cover surface and the water drop W is approximately 91°. This increases the height of the water drop W from the cover surface of the cover, that is, increases the thickness d of the water drop W. Thus, the water drop W greatly attenuates radio waves that are transmitted through the cover and the water drop W.

A cover of a second comparison example is formed from isosorbide copolymerized polycarbonate and includes a transparent member, which serves as the surface of the cover.

In the cover of the second comparison example, a water drop W wets and spreads on the cover surface, and the contact angle θc of the cover surface and the water drop W on the cover is approximately 77°. This decreases the thickness d of the water drop W. However, the water drop W partially permeates the cover and changes the permittivity of the cover. This greatly attenuates radio waves that are transmitted through the water drop W on the cover surface.

In the cover 10 of the present embodiment, the transparent member 20 that serves as the surface of the cover 10 is formed from polyester copolymerized polycarbonate in which the contact angle θc of the water drop W and the cover surface is approximately 84°. Under a condition in which the contact angle θc of the surface of the cover 10 and the water drop W is 80° or greater and 90° or less, when a water drop falls onto the surface of the cover 10, the thickness d of the water drop W is small. This limits permeating of the water drop W on the surface into the transparent member 20. As the contact angle θc decreases, the water absorption rate of the cover 10 increases. Thus, when the contact angle θc is 83° or greater and 87° or less like in the cover 10 of the present embodiment, the water absorption rate is 0.2% or less. This limits permeating of the water drop W on the surface of the cover 10 into the transparent member 20. Thus, attenuation of the radio waves is limited when radio waves are transmitted through the cover 10 and the water drop W.

The inventors of the present invention applied a predetermined amount of water drops to the surface of each cover over a predetermined area and measured the attenuation amount when radio waves were transmitted through the cover and the water drops.

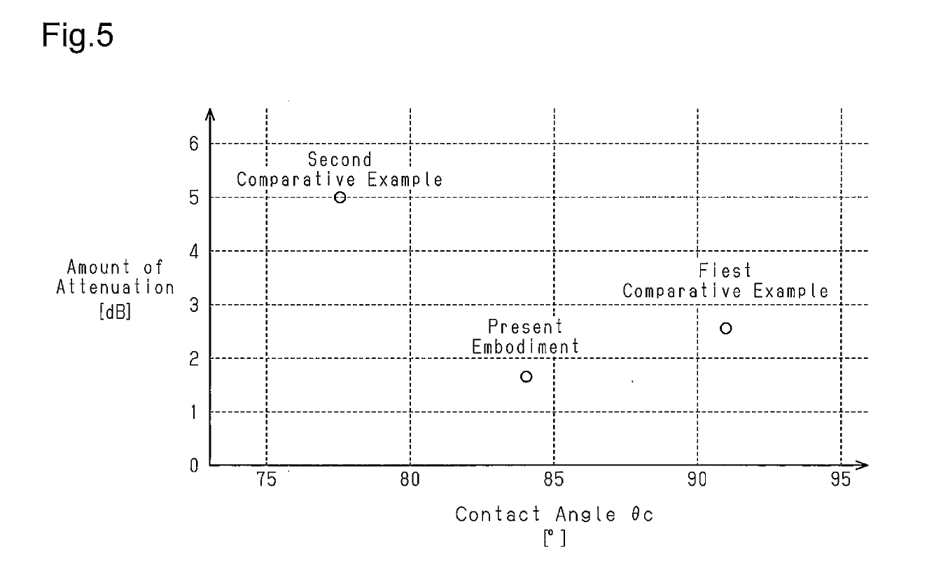

As shown in FIG. 5, the attenuation amount of radio waves was approximately 2.6 dB in the cover of the first comparison example, and the attenuation amount of radio waves was approximately 5.1 dB in the cover of the second comparison example. The attenuation amount of radio waves was approximately 1.7 dB in the cover 10 of the present embodiment.

Table 1 shows the relationship of the material of the transparent member that serves as the surface of the cover and the test results of different properties. In Table 1, PC refers to polycarbonate (first comparison example), PMMA refers to polymethyl methacrylate resin (first reference example), and PDMS refers to dimethylpolysiloxane (second reference example). In the first and second reference examples, the material of the transparent member was changed and tests were conducted in the same manner as the present embodiment. The test results are shown in Table 1.

TABLE 1

| | | | | Second | Second |
|---|---|---|---|---|---|
| | Present | | | Reference | Comparison |
| | Embodiment | First | First | Example | Example |
| | Polyester | Comparison | Reference | PDMS | Isosorbide |
| | Copolymerized | Example | Example | Copolymerized | Copolymerized |
| | PC | PC | PMMA | PC | PC |
| Presence of | No | Yes | No | No | No |
| Hard Coat | | | | | |
| Contact | 84 | 91 | 82 | 91 | 77 |
| Angle | | | | | |
| Water | Good | Good | Not | Good | Not Acceptable |
| Absorption | | | Acceptable | | |
| Rate | | | | | |
| Impact | Good | Good | Fair | Good | Not Acceptable |
| Resistance | | | | | |
| Weather | Good | Good | Good | Not Acceptable | Good |
| Resistance | | | | | |
| Adhesiveness | Good | Good | Not | Good | Good |
| of Metal | | | Acceptable | | |
| Layer | | | | | |

In this table, the item indicated as water absorption rate shows the measurement result of the water absorption rate of the transparent member that was placed for 24 hours in an environment in which the temperature was 23° C. and the relative humidity was 100%. When the water absorption rate of the transparent member was 0.2% or less, the water absorption rate was evaluated as good. When the water absorption rate was greater than 0.2%, the water absorption rate was evaluated as not acceptable.

The item indicated as impact resistance shows the result of a falling weight impact test conducted with a falling weight of 4.9 N on a transparent member that was placed for 3 hours in an environment in which the temperature was −15° C. More specifically, the impact resistance was evaluated as good when the minimum fracture strength of the transparent member was greater than 5 J, the impact resistance was evaluated as fair when the minimum fracture strength of the transparent member was greater than 1 J and 5 J or less, and the impact resistance was evaluated as not acceptable when the minimum fracture strength of the transparent member was 1 J or less.

The item indicated as weather resistance shows the result of a sunshine weather test conducted for 1000 hours. The weather resistance was evaluated as good when the color difference ΔE of the transparent member was 3 or less, and the weather resistance was evaluated as not acceptable when the color difference ΔE was greater than 3.

The item indicated as adhesiveness of the metal layer 32 shows the result of a test conducted in compliance with JIS K5600-5-7. The adhesiveness of the transparent member was evaluated as good when the adhesiveness was 1 MPa or greater, and the adhesiveness was evaluated as not acceptable when the adhesiveness was less than 1 MPa.

As shown in Table 1, the transparent member 20 that serves as the surface of the cover 10 of the present embodiment satisfies the properties required for an emblem with regard to the water absorption rate, the impact resistance, the weather resistance, and the adhesiveness of the metal layer.

The above radio wave transmissive cover of the present embodiment has the advantages described below.

(1) The cover 10 includes the transparent member 20, which serves as the surface of the cover 10, and the ornamental layer 30, which is formed on the rear surface of the transparent member 20. The transparent member 20 is formed from a resin material. The resin material is selected so that when a water drop falls onto the surface of the transparent member 20, the contact angle θc of the surface and the water drop is 80° or greater and 90° or less.

This reduces the thickness d of the water drop W on the surface of the cover and limits permeating of the water drop W on the surface of the cover 10 into the transparent member 20. Accordingly, even if there is a water drop W on the surface of the cover 10, attenuation of radio waves is limited when the radio waves are transmitted through the cover 10 and the water drop W.

The ornamental layer 30 is formed on the rear surface of the transparent member 20, and the surface of the transparent member 20 serves as the surface of the cover 10. This simplifies the layer structure of the cover 10, which differs from the conventional structure in which a hard coating is applied to the surface of a transparent member.

(2) The transparent member 20 is formed from polyester copolymerized polycarbonate.

This significantly limits attenuation of radio waves transmitted through the cover 10 and water drops, which are collected on the surface of the cover 10.

It should be apparent to those skilled in the art that the present invention may be embodied in many other specific forms without departing from the spirit or scope of the invention. Particularly, it should be understood that the present invention may be embodied in the following forms.

The resin material that forms the transparent member may be changed to another resin material that obtains the contact angle θc of 83° or greater and 87° or less.

For example, an outer layer of polyester copolymerized polycarbonate may be formed on an inner layer of polycarbonate so that the outer layer serves as the surface of the cover.

The present examples and embodiments are to be considered as illustrative and not restrictive, and the invention is not to be limited to the details given herein, but may be modified within the scope and equivalence of the appended claims.

1. A radio wave transmissive cover arranged in a path of a radio wave of a radio wave radar device, the radio wave transmissive cover comprising:
a transparent member that serves as a surface of the cover, wherein the transparent member is formed from a resin material adapted so that when a water drop falls onto the surface, a contact angle of the surface and the water drop is 80° or greater and 90° or less.

2. The radio wave transmissive cover according to claim 1, wherein the transparent member is formed from a resin material adapted so that when a water drop falls onto the surface, a contact angle of the surface and the water drop is 83° or greater and 87° or less.

3. The radio wave transmissive cover according to claim 2, wherein the transparent member is formed from polyester copolymerized polycarbonate.

4. The radio wave transmissive cover according to claim 1, wherein an ornamental layer is formed on a rear surface of the transparent member.

5. The radio wave transmissive cover according to claim 4, wherein the ornamental layer includes a colored layer formed on the rear surface of the transparent member, a metal layer formed in the transparent member on a rear surface of the colored layer, and an anti-corrosion layer formed on a rear surface of the metal layer.
